(19) United States
(12) Patent Application Publication
(10) Pub. No.: US 2008/0245610 A1
(43) Pub. Date: Oct. 9, 2008

(54) Personal Emergency Rescue Belt

(76) Inventor: Sang-Ik Lee, Seoul (KR)

Correspondence Address: IPLA P.A., 3580 WILSHIRE BLVD., 17TH FLOOR, LOS ANGELES, CA, 90010, US

(21) Appl. No.: 12/066,358

(22) PCT Filed: Sep. 11, 2006
(86) PCT No.: PCT/KR2006/003598

§ 371 Date: Mar. 10, 2008

(30) Foreign Application Priority Data
Sep. 12, 2005 (KR) 10-2005-0084774

(51) Int. Cl. A62B 35/00

(52) U.S. Cl. 182/5; 182/3

(57) ABSTRACT

The present invention, the PERB, relates to a personal emergency rescue/security belt. The PERB is comprised of one band with the body (10); forming ″ shape, and with the use of the first tri-glide lock (13a, 13b); which adjust the body formed “ ” shape by fixing intersection points (11, 12) in which a band meets, and it is characterized by a first binding buckle (18a, 18b) that locks together; binding both extended ends from an intersection point of the said band. The present invention described in the above, simplifies the configuration. The PERB can be put on rapidly and easily, and the cost is lower and is more light-weight, and provides multi-purposes. The PERB is changeable into emergency life-saving equipment to carry a person on a rescuer's back, under a rescuer's arm, or on a stretcher. Particularly, in the case of an emergency, the injured person is rapidly escorted from the accidental disaster, or he may escape by means of putting the PERB on by himself to reach safety. And, the object of the PERB is to provide low-cost, light-weight, multi-functionality use that attracts the customer's interest that can also be used in the general home, to rescue a victim trapped in a fire. In addition, the object of the PERB is to provide a supplementary transfer device for poor disabled people for daily use.

### TECHNICAL FIELD

The present invention relates to a personal emergency rescue/security belt (PERB). The PERB is portable and wearable, and it is equipment which makes it easy to secure and carry an injured person on the rescuer's back, or as an arm support to help secure an injured person with a broken leg, or on a stretcher transformed according to the situation. The PERB can also be used to rappel an injured person who is alone. This is especially useful if someone is in a remote area and help is not available. The PERB can easily be attached to a rope. After being attached to a rope the injured person will be able to descend easily. In an emergency situation a victim can rapidly put on the PERB without help so that the victim could be hooked to a rappel rope, rope from a helicopter, or if caught or being drowned in fast moving river or stream.

### BACKGROUND ART

The conventional safety belt, as shown in FIG. 19 (the registration number: 20-0187083-0000 reference), has pouches with a zipper etc. wherein a guard ring is stored. When an emergency occurs the guard ring can be taken out from the pouches. In other wise, there are also luminous patches that adhere to the safety belt in order to distinguish the user in the darkness. As to the said safety belt (V) comprised to the suspender-shape shoulder belt (1), waist-belt (2), and the fixed belt (3) is worn on the legs are adhered to, the said safety belt (V) is characterized to adhere to the fire coat or the rescuer's jacket with pouches (5) that contains guard ring or hook (4) with zipper (6) which can be taken in/out according to the situation in normal/using time, are equipped at the front of the guard ring (4) depending on safety belt (V). But It is difficult to use during a disaster or to carry because of the way that the safety belt is attached to the fire coat or the rescuer's jacket, and the high production cost makes it difficult for common families to purchase.

Moreover, the alternative formal safety belt (the registration number: 20-0192940-0000 reference) has a problem because the victims hesitate to rely upon the tow line or the rope in the higher stories because it does not look or feel secure. It just winds around the waist or armpit, or just binds to the groin and shoulder or groin and waist.

### DISCLOSURE OF INVENTION

### Technical Problem

The present invention was worked out in order to solve above-described problem. First, the object of the present invention (PERB) simplifies the configuration. The PERB can be put on rapidly and easily, and the cost is lower and is more light-weight, and provides multi-purposes. The PERB is changeable into life saving equipment or emergency carry a person on a rescuer's back, under rescuer's arm, or on a stretcher.

Second, particularly, in the case of a disabled person, there are many poor families that complain about not having equipment to transport their disabled/injured child. Currently there is no proper equipment that is available to transport any aged child. The second advantage of the PERB is to provide a supplementary transfer device for poor disabled people without a wheelchair, or even if they have a wheelchair, the wheelchair does not go up the stairs or roll on irregular ground.

Next, the third object of the PERB is that the PERB reduces the psychological uncertainty of the victim by evenly surrounding the whole body because the system is connected to a hauling rope (52) at the chest in an emergency situation. Furthermore, the PERB also can be used to tow on injured person back to safety like conventional safety belts that are used in the field of sky-scraper construction.

### Technical Solution

To solve the previous problems, the PERB, according to the present invention is comprised of one band that is adjustable and can conform to the body shape, regardless of weight or height. This is accomplished with the use of first tri-glide lock (13a, 13b) which adjust the said body (10) formed “ [symbol] ” shape by fixing intersection points (11, 12) in which a band meets, and is characterized by a first binding buckle (18a, 18b); that locks together binding both extended ends from an intersection point of the said band. The band, tri-glide lock, and binding buckles are all one piece of equipment. The shape of the band becomes adjustable because of the tri-glide lock to fit all human shapes, including binding buckles, is one complete band of equipment that can be used in any situation.

Moreover, it is preferable that the first [symbol] -shaped tri-glide lock (13) at the second intersection (12) moves on the said body (10) is further included.

Moreover, it is preferable that the chest belt (16a,16b) which slides and is fixed to the upper part (17) of said body (10), and which has a pair of second binding buckles (19a, 19b) is further included.

Moreover, It is preferable that an X-type assistance suspender (20); wherein a third binding buckle (21a, 21b) unites with the said second binding buckle (19a,19b) on the upper part, and a fourth binding buckle (22a,22b) unites with the said first binding buckle (18a, 18b) in the lower part is further included.

Moreover, it is preferable that a linear type shoulder strap (31) is further included; wherein a fifth binding buckle (32a,32b) is equipped at both ends, and the ladder-lock buckle (30) combines with the said body (10) in the middle.

Moreover, it is preferable that a pair of shoulder pads (41); configured so that it is removable from the shoulder section (15) of the said body (10) by velcro tape (40), is further included.

Finally, it is preferable that the circular hauling band (50); combined with the said body (10) and rappel rope (52) for lowering escape means, and karabiner (51) which connect the hauling band (50) to rappel rope (52) are further included.

### ADVANTAGEOUS EFFECTS

As described above, the PERB has the advantage that the injured person is rapidly escorted from an emergency disaster, or he may escape by means of putting the PERB on by himself to reach safety.

Especially, the configuration and use of the PERB is convenient in comparison with the existing rescue equipment, because it is more efficient and easier to put on in the case of an accident, which brings immediate and efficient first aid. In additional to the low-cost, light-weight, multi-functionality use that attracts the customer's interest also can be used the general home to remove someone from a fire.

At the same time, in the home a handicapped person can use the PERB as a supplementary carrying device.

### BRIEF DESCRIPTION OF THE DRAWINGS

FIG. 1 is a perspective view of the PERB and shows the basic component parts.

FIG. 2 is a perspective view of the PERB, the chest belts (16a,16b) affixed thereto.

FIG. 3 shows the supplementary paraphernalia of the PERB for the preferred embodiments.

FIG. 4 is a front view of the first preferred embodiment of the PERB, and shows a injured person being carried on the rescuer's back.

FIG. 5 is a side view of the first preferred embodiment of the PERB, and shows an injured person being carried on the rescuer's back.

FIG. 6 is a rear view of the first preferred embodiment of the PERB, and shows an injured person being carried on the rescuer's back.

FIG. 7 is a front view of the second preferred embodiment of the PERB, and shows a injured person being supported by the help of a rescuer.

FIG. 8 is a front view of the third preferred embodiment of the PERB, and shows a victim who is wearing the PERB for air rescue.

FIG. 9 is the plane view of the 4th preferred embodiment of a PERB, and shows a stretcher made of two PERBs with climbing sticks

FIG. 10 shows a victim lying down and fixed on the stretcher of the 4th preferred embodiment of a PERB.

FIG. 11 is the development view of the 5th preferred embodiment of a PERB to wear for emergency rescue.

FIG. 12 is the front view of the user who is putting on a PERB in the 5th preferred embodiment for emergency rescue.

FIG. 13 is the side view of the user who is putting on a PERB in the 5th preferred embodiment for emergency rescue.

FIG. 14 is the rear view of the user who is putting on a PERB in the 5th preferred embodiment for emergency rescue.

FIG. 15 is the front view of the user who is putting on a PERB in the 5th preferred embodiment, wherein an assistance suspender (20) is added to the PERB.

FIG. 16 is the side view of the user who is putting on a PERB in the 5th preferred embodiment, wherein an assistance suspender (20) is added to the PERB.

FIG. 17 is the rear view of the user who is putting on a PERB in the 5th preferred embodiment, wherein an assistance suspender (20) is added to the PERB.

FIG. 18 shows an emergency rescue using of the 5th preferred embodiment of a PERB with the use of a rope (52) and karabiner (51).

FIG. 19 shows a person wearing the conventional rescue belt.

### NUMERALS IN DRAWINGS

10: A body of the PERB. 10a: The arc. 10b: The cord.
11, 12: Intersection point. 9: The 2nd tri-glide lock.
13a, 13b: The 1st tri-glide lock. (=sliplock buckle)
14: waist belt. 15: shoulder section. 16: chest belt.
17: upper part of the body. 17a: Back section.
18a, 18b: a pair of 1st binding buckles.
19a, 19b: a pair of 2nd binding buckles. 20: assistance suspender.
21a, 21b: a pair of 3rd binding buckles.
22a, 22b: a pair of 4th binding buckles.
30: ladder-lock buckle. 31: shoulder-strap.
32a, 32b: a pair of 5th binding buckles.
40: velcrotape. 41: shoulder-pads. 42: flap.
50: hauling band. 51: karabiner 52: rappel rope
61: binding band. 62: loop of climbing stick.

### BEST MODE FOR CARRYING OUT THE INVENTION

The PERB will now be described in connection with the five embodiments, which will be exemplarily depicted in the accompanying drawings. Hereinafter, referring to the figure, the first preferred embodiment, second embodiment, third preferred embodiment, fourth preferred embodiment, fifth preferred embodiment of the PERB are to illustrate. The same reference numerals presented in the drawing shows the same part in all drawings.

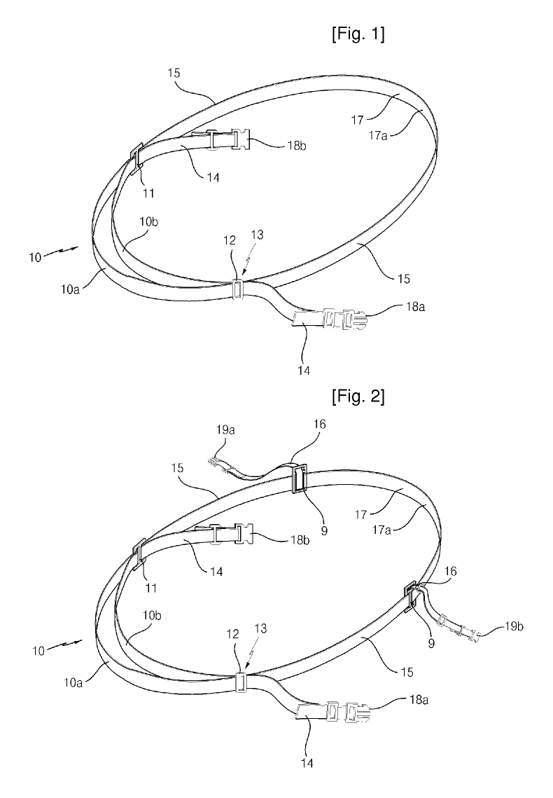

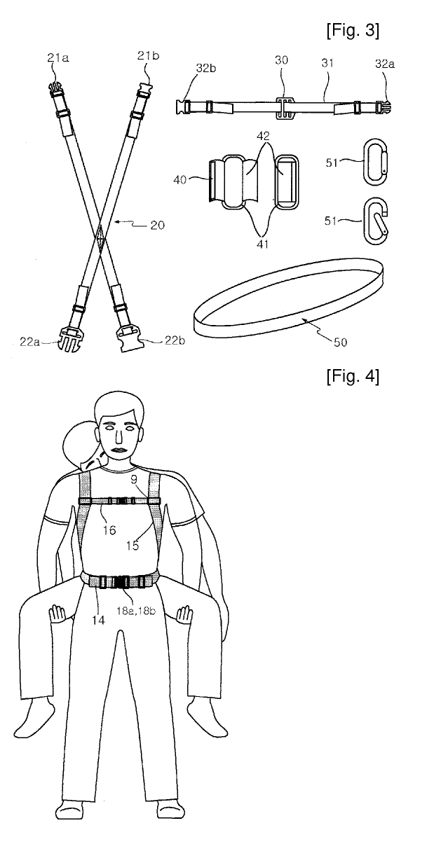

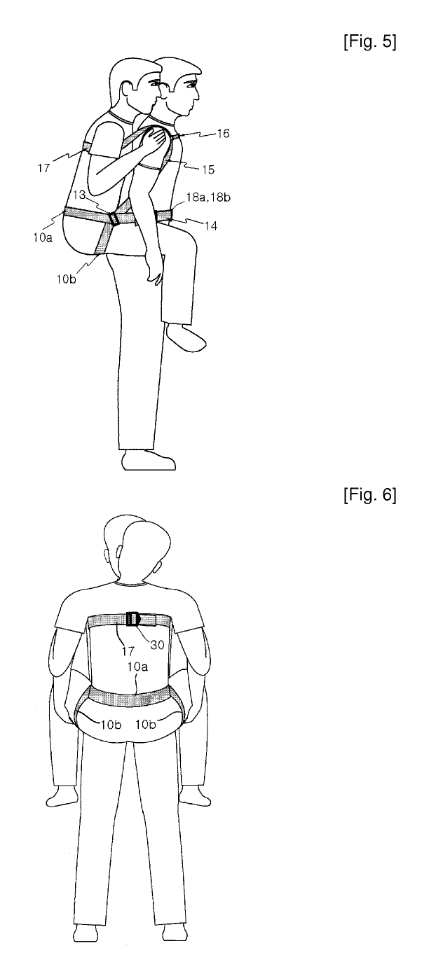

FIG. 1 is a perspective view of the PERB and shows the basic component parts and FIG. 2 is a perspective view of the PERB, the chest belts (16a,16b) affixed thereto and FIG. 3 shows the supplementary paraphernalia of the PERB for the 4th and the 5th preferred embodiments.

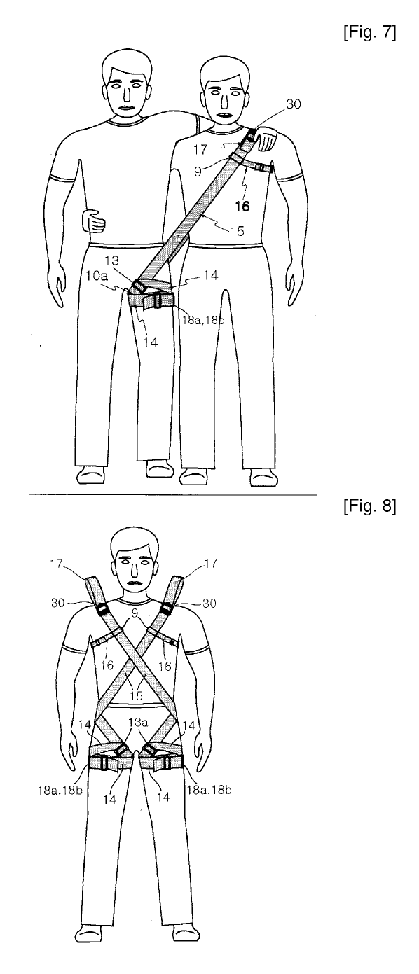

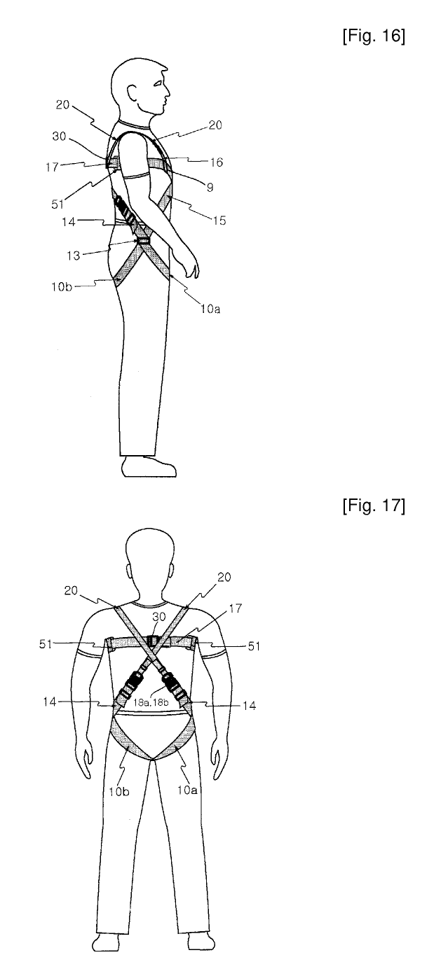

Directing attention hereinafter to FIGS. 1 through 4, and to FIGS. 7 through 11, and to FIGS. 15 through 18, details are provided regarding various features of the 5 embodiments of the PERB.

It is preferable that the rescue belt for personal escort according to the first preferred embodiment is comprised of the body (10), the first tri-glide lock (13a,13b), waist belt with first binding buckles (18a,18b), the chest belt (16) including second binding buckles (19a,19b), and shoulder-pads (41).

The said body (10) has the shape of “ [symbol] ” overlapped in intersection points (11, 12) which crosses and intersect at the tri-glide lock (13a, 13b) of the band and have predetermined widths and lengths which are in a circular, detailed in FIG. 1. At this time, both end parts of the said body (10) maintain suitable lengths from intersection points (11, 12), and the two webbings protruding from both intersection points (11,12) play the role of the waist-belt (14).

Between both intersection points (11, 12), the body arcs (10a) and the cord (10b) overlap each other. And they may prevent the belt from loosening by sewing the first intersection point (11), which is a circular constant size because it is sewn secure.

And they may control the length to fit to a person's body with the first adjustable tri-glide lock (13b) on the second intersection (12), the said arc (10a) and the cord (10b) circle around buttock top and bottom of the victim. They play the role of evenly dispersing the weight of the person being rescued to a rescuer's back and shoulder.

The first binding buckle (18a, 18b) is equipped at both ends of the waist-belt (14), which can quickly be banded together, and which is detachable.

The waist-belt (14) plays the role of evenly dispersing the weight of the victim onto the waist of the rescuer and the role of sticking the victim fast to the rescuer's back. They spread out from intersection points (11, 12) and become a portion of the body (10) as shown in FIG. 1.

The back section (17a) is part of the upper body (17) of the opposite columnar arc (10a) and the cord (10b), and it is united with the shoulder section (15) surrounding the victim's back, and passing the victim's armpits and hanging on the rescuer's shoulder, and which adhere the victim closely to the rescuer's back. Therefore, this enables the victim to be maintained securely on the rescuer's back, even if the victim is unconscious. Even in the case of consciousness, the victim maintains a stable state on the rescuer's back.

Moreover, the linear type band at the 5th binding buckles (32a, 32b) on both ends of the shoulder-strap (31) is connected to the ladder lock (30) which will be described later, and both ends cross over the rescuer and possibly the victims, shoulders and the length can be united with the chest belt (16). The said shoulder-strap (31) prevents the back section (17a) from streaming down while a user is waiting for rescue, and it may connect with the 2nd binding buckles (19a, 19b) which are equipped at both ends of the chest belt (16).

As shown in FIG. 3, the said ladder lock (30) which is attachable and detachable may control the length of back section (17a) according to a person's figure, and which can make the victim secure to the rescuer's back.

The shoulder section (15) plays the role of dividing the weight of the victim into the rescuer's shoulder as a part of the body (10) between the intersection points and second fixture (9) which will be described later (11,12).

The said chest belt (16) is used as the droop prevention of the shoulder section (15) bearing most of the weight of the victim, and it is fixed to the second ladder-lock (9) on the spot of the shoulder section (15) which are between the two intersection points (11, 12). And it secures the shoulder sections (15) fast to the rescuer's chest by means of connecting the 2nd binding buckle (19a, 19b).

Moreover, the said chest belt (16) connects to the second tri-glide lock (9) which is slidable up and down on the shoulder section (15), so they can adapt to the positioning change by deformation of the circular belt, in other words as shown in FIG. 10, when using the PERB for emergency rescue. It is preferable that the shape of a ladder lock which has a similar shape as the 2nd tri-glide buckle (9) described in the above, has a D-ring on both sides which the chest belt (16) slides through to fix on the shoulder section (15).

Now, the second embodiment of the PERB is described next.

As shown in FIG. 7, the body (10), arc (10a), cord (10b), waist-belt (14), chest belt (16) are used for the desirable second embodiment of the PERB.

And by using the waist-belt (14), the arc (10a) and the cord (10a), the leg of the injured person is fixed and the back section (10a) and the chest belt (16) are fixed to the shoulder of a rescuer. It is possible for a rescuer to support the weight of the injured person by the belt fixed to the shoulder, at the same time, may help him with the other arm.

The third preferred embodiment of the PERB is described next.

The body (10), arc (10a), cord (10b), waist-belt (14), chest belt (16) is used for the 3rd preferred embodiment, which needs a pair of PERBs.

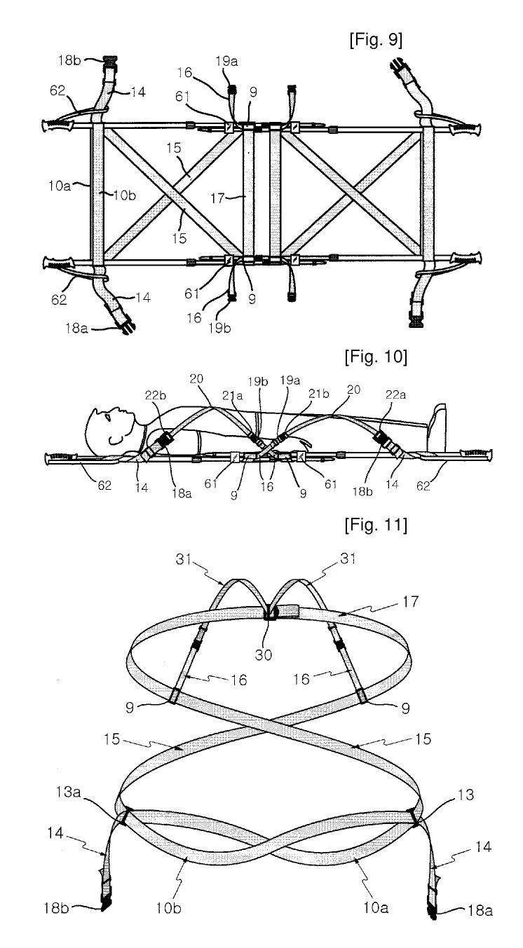

FIG. 8 and FIG. 9 show the desirable third preferred embodiment of the PERB. By using the arc (10a), the cord (10b), and the waist-belt (14), the injured thigh of the victim is fixed as the same as the second embodiment. And next, the shoulder sections (15) are crossed in X form waist high, and the back section (17a) and chest belt (16) are fixed on the other side shoulder and armpit of the rescuer. A pair of the PERBs can make a symmetrical pattern. At this time, if the length is controlled in order to adhere the back section (17a) closely to the shoulder of the victim's with the ladder-lock buckle (30), an extra loop is formed on the shoulder which can tow the victim. Two loops can be formed from the back section (17a) and can be used to lift rescuer and victim to safety. In the latter case, since the hauling point is the shoulder, the body of the injured person can be put erect or perpendicular, It has the advantage of avoiding dangerous articles including the eaves or protruding rock etc. and they can safely move the injured person.

From now on, the fourth preferred embodiment of the PERB is described.

FIG. 9 and FIG. 10 show the desirable 4th preferred embodiment of the PERB. The body (10), the arc (10a), the cord (10a), waist-belt (14), chest belt (16), suspender (20), hauling band (61) are used in order to comprise the stretcher of the preferred 4th embodiment. And a pair of the PERBs are used for a stretcher, too. Hereinafter, referring to FIG. 9, and FIG. 10, the formation and function of the desirable 4th preferred embodiment for a stretcher are to be illustrated.

FIG. 9 is the plane view of a stretcher using two PERBs and hiking sticks. After the shoulder section (15) both are crossed in an X shape and the body (10) is made with ∞ shaped feature, the insides in which the arc (10a) and cord (10b) are comprised of an oval and the back section (17) of the body (10) which form an X, 2 sticks with a distance attached therethrough. And the waist-belt (14) that penetrates the loop of the hiking sticks winds around the frame of the hiking sticks twice or so, this prevents the said body (10) from moving and sliding on the frame of the sticks. In that way, as shown in FIG. 9 or FIG. 10, a pair of the PERB composed of a [symbol] form are symmetrically, and the overlapped part of both sticks are rigidly fixed with the binding bands (61).

FIG. 10 is the exemplary 4th embodiment using the 2 PERBs as a stretcher. The 2 suspenders (20) which will be described later are placed on the upper and the lower part of the injured person lying on the stretcher. And it bands together at the first binding buckles (18a, 18b) of the waist-belt and 2nd binding buckles (19a, 19b) of the chest belt, then the injured person is rigidly fixed to a stretcher. At this time, the 3rd binding buckles (21a, 21b) from a suspender (20) and cross-connect with the second binding buckles (19a, 19b) of the chest belt on the opposite side, to make a stretcher from two PERBS, “

[symbol]

” shape of the stretcher that is not separated or deformed.

Now, the 5th preferred embodiment of the PERB is described.

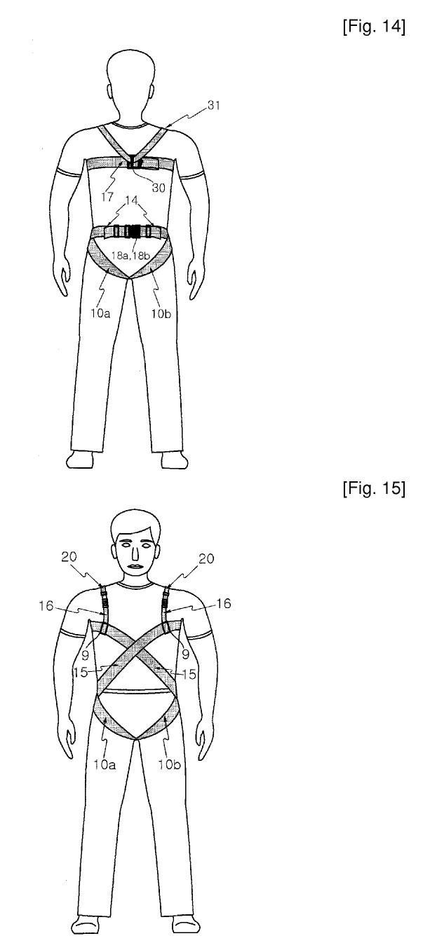

FIG. 10 to 18 are use illustrations of the PERB for emergency rescue. The body (10), waist belt (14), chest belt (16), suspender (20), shoulder strap (31), hauling band (50) karabiner (51), rope (52) are used for the 5nd preferred embodiment of the PERB. Hereinafter, referring to FIG. 11, and FIG. 15 through 18, the formation and function of the desirable 5th preferred embodiment for emergency rescue are to be illustrated.

FIG. 11 is the development figure of the PERB that is ready to put on alone at behind.

After both end parts of the said arc (10a) and the said cord (10a) are twisted to make ∞ form, they put the legs into the holes to have the middle intersection adhere to the perineal region closely, and turn the waist-belts (14) behind and fix them tight on top of the hip.

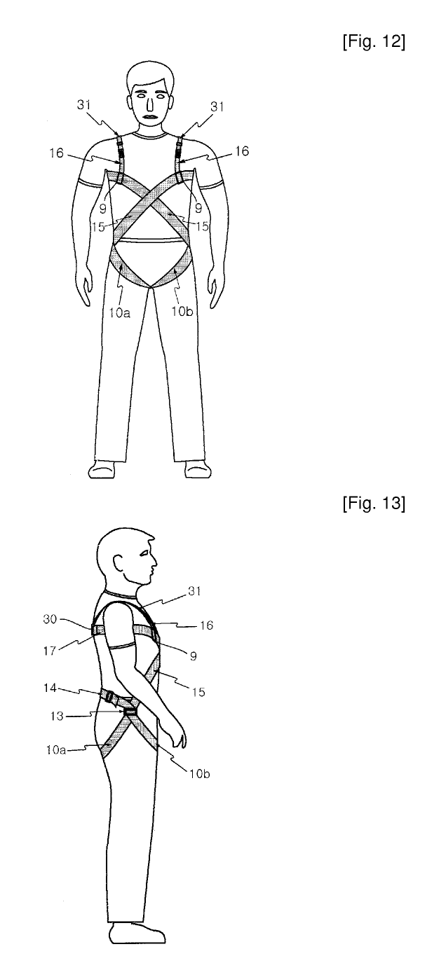

As shown in FIG. 12 through 14, after crossing the shoulder section (15) in X form on the chest, they are put on the back section (17a) overhead and placed under the armpit. And then, the shoulder-strap (31) joined with a ladder lock (30) is connected to the chest belt (16) over the shoulder vertically so that the back section (17a) is kept at the armpit height fixed and secure.

The chest belt (16) including the 2nd binding buckle (19a, 19b) and the 2nd tri-glide lock (9) which is slidable on the shoulder section (15) may connect with the 3rd binding buckle (21a, 21b) within the suspender (20) which will be described later at the chest according to the wearing condition.

The back section (17a) controls the length by folding the ladder lock buckle (30) to fit any person's body.

FIG. 15 through FIG. 17 are diagrams of putting on the suspender (20) in FIG. 3. The X shaped suspender (20), has the third binding buckles (21a, 21b) second binding buckles (19a,19b) at the top ends, and 4th binding buckles (22a, 22b) connecting with the 1st binding buckles (18a,18b) at the bottoms. The said suspender (20) prevents drooping the arc (10a) and cord (10b) under perineum by connecting waist belt (14) with chest belt (16) over the shoulder instead of the waist-belt (14) at the top of the hip. So, it makes the PERB adhere to the body of a victim tightly, and it also unites the victim to the stretcher rigidly. Therefore, it plays the role of preventing any risk of injury to the body of the person being rescue.

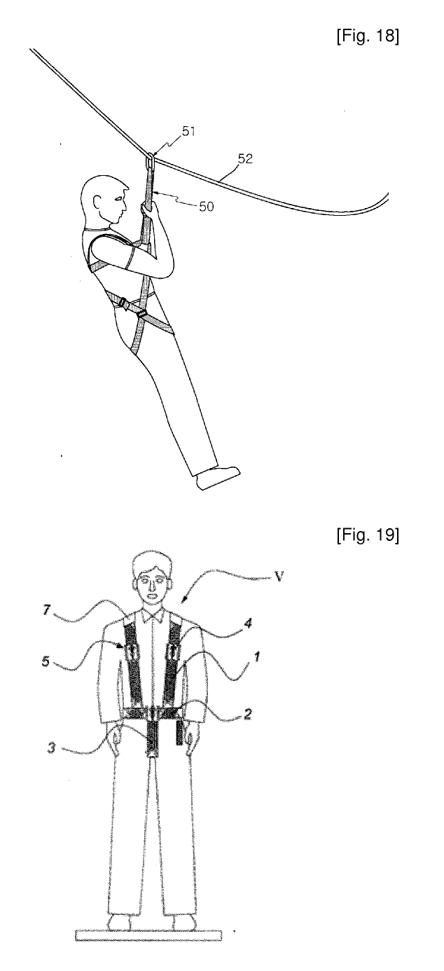

FIG. 18 shows the embodiment of the emergency escape by using the PERB. The hauling band (50) plays the role of delivering the weight of the victim in the emergency rescue by rappel rope (52) which will be described later, and that is comprised of the fabric band of the closed circle is preferable. One end of the hauling band (50) passes through the part in which the shoulder sections (15) are crossed at the chest, the other end part connects to the karabiner (51) which will be described later.

The route of emergency rescue, by rappel rope (52) depends on weight of victim who is chained to the hauling band (50) by karabiner (51) which will be described later. In hilly areas, a victim is able to escape to lower a place by the rappel rope (52), and the horizontal escape is possible in case the victim is drowning or caught in fast moving water.

The karabiner (51) which is generally used as mountain climbing equipment has the advantage that the mutual switch of the enclosed type and open type are simple using a spring. And it is usable for not only connecting the hauling band (50) and rappel rope (52), but also connecting the body (10) and hauling band (50). In this case, it has the advantage that it is connectable with the hauling band (50) even after a victim put on body (10) of the PERB. Particularly, the extra descending device which connects the body (10) and rappel rope (52) is available.

As shown in FIG. 3, the shoulder-pads (41), include the Velcro tape (40) in the flap (42) and are detachable, and they protect the rescuer's shoulder while the injured person is escorted on the rescuer's back, and they also protect the armpit of the victim who is wearing the PERB for emergency rescue.

Otherwise, each end of the body (10), chest belt (16), suspender (20), shoulder strap (31) includes a tri-glide lock so that the length is adjustable.

Moreover, they will be able to deal with any disaster at nighttime effectively because a fluorescent label is adhered to the PERB.

### MODE FOR THE INVENTION

In the above, the optimum embodiments are disclosed in FIGS and specification. Here, specific terms were used. But those are used not to limit the meaning or the range of the PERB written in patent claims but to illustrate the PERB. Therefore, In view of the foregoing description it will be evident to a person skilled in the art that various modifications may be made within the scope of the PERB. So, the true extent of technical protection should be determined by the technical mapping of the specification, in conjunction with the drawings and the appended claims.

### INDUSTRIAL APPLICABILITY

In the field of leisure as like trekking, rock climbing, aquatic sports, snow skiing, and in the field of emergency evacuation during fire fighting, and in the field of tall building construction, and in the field of welfare for the disabled, and in the field of military equipment, the present invention is personal emergency rescue equipment which can be widely used.

I claim:

1. A personal emergency rescue belt (PERB) comprising; a body, which is comprised of one band and forms “ [symbol] ” shape: and the first tri-glide locks (13a,13b) in which said band comprises “ [symbol] ” shape by fixing the intersection points (11,12) in which both ends of the said band meet: and a pair of first binding buckles (18a,18b) that binds the protruding ends of the said body (10).

2. A personal emergency rescue belt (PERB) comprising; a body, which is comprised of two bands and forms “ [symbol] ” shape: and the first tri-glide locks (13a,13b) in which said bands comprises “ [symbol] ” shape by fixing the intersection points (11,12) at which the said bands meet: and a pair of first binding buckles (18a,18b) that binds the protruding ends of the “ [symbol] ” shape band of the said body (10): and another pair of binding buckles that binds the ends of the “U” shape band of the said body (10).

3. The PERB as recited in claim 1 or claim 2, wherein at least one of the said first tri-glide locks (13) is slidably fixed on the said body (10).

4. The PERB as recited in claim 1 or claim 2, further comprising a pair of chest belts (16a,16b) which is combined to the upper part of the said body (17) between the said intersection points (11,12), and moves on the said upper part (17), and is equipped with a pair of second binding buckles (19a, 19b) at each end.

5. The PERB as recited in claim 1 or claim 2, further comprising X-type assistance suspender includes that a pair of third binding buckles (21a,21b) on the tops unite with the said second binding buckles (19a,19b) of the said chest belt, and a pair of fourth binding buckles (22a,22b) at the bottom mite with the said first binding buckles (18a,18b).

6. The PERB as recited in claim 1 or claim 2, further comprising a linear type shoulder strap (31); wherein a pair of fifth binding buckles is equipped at both ends, and the ladder-lock buckle combines with the said body (10) in the middle.

7. The PERB as recited in claim 1 or claim 2, further comprising a pair of shoulder pads (41); which configured so that it is detachable from the shoulder section (15) or the back section (17a) of the said body (40).

8. The PERB as recited in claim 4, further comprising: the circular hauling band (50) combined with the said upper part (17) of the said body: and rappel rope (52) for lowering escape means, and karabiner (51) which connects the hauling band (50) to a rope.
